(19) United States
(12) Patent Application Publication
(10) Pub. No.: US 2016/0042545 A1
(43) Pub. Date: Feb. 11, 2016

(54) DISPLAY CONTROLLER, INFORMATION PROCESSING APPARATUS, DISPLAY CONTROL METHOD, COMPUTER-READABLE STORAGE MEDIUM, AND INFORMATION PROCESSING SYSTEM

(71) Applicant: FUJITSU LIMITED, Kawasaki-shi (JP)

(72) Inventor: Itaru Hiraki, Yokohama (JP)

(73) Assignee: FUJITSU LIMITED, Kawasaki-shi (JP)

(21) Appl. No.: 14/885,406

(22) Filed: Oct. 16, 2015

Related U.S. Application Data
(63) Continuation of application No. PCT/JP2013/061406, filed on Apr. 17, 2013.

(51) Int. Cl. G06T 11/60; G06T 11/00; G06F 3/14

(52) U.S. Cl. CPC G06T 11/60; G06F 3/14; G06T 11/001

(57) ABSTRACT

A display controller includes a processor. The processor is adapted to generate character attribute information based on a display condition for a first application; record the generated character attribute information in a storage device; and in response to a second application being launched, obtain the character attribute information from the storage device, and change a display condition for the second application, based on the obtained character attribute information.

### CROSS-REFERENCE TO RELATED APPLICATION

This application is a continuation application of International Application PCT/JP2013/061406 filed on Apr. 17, 2013 and designated the U.S., the entire contents of which are incorporated herein by reference.

### FIELD

The embodiment discussed herein relates to a display controller, an information processing apparatus, a display control method, a non-transitory computer-readable storage medium having a display control program stored therein, and an information processing system.

### BACKGROUND

With evolutions of information communication technologies in recent years, an increasing number of personal users employ multiple information processing devices, e.g., personal computers (PCs), mobile phones, and smart phones.

In one most typical scenario, a user employs a PC at his or her workplace or at home, and goes outdoors, carrying a mobile phone or a smart phone.

For example, when the user browses a web page on the home PC, he or she may want to resume reading of the page on a mobile device, e.g., a smart phone or a mobile phone.

Meanwhile, screens of typical mobile devices, e.g., smart phones and mobile phones, are smaller than screens of PCs, and hence characters, or letters, are generally displayed in smaller sizes. Thus, when users want to use their mobile devices to resume task that they did on their PCs, most of them enlarge the size of characters displayed on the mobile devices.

In addition, every time an application is launched on a typical mobile device, that application is displayed on the screen using the default character size setting. Some users are annoyed to change the setting for character display size, every time they launch applications.

The present embodiment has been envisioned in light of the above-identified issues, and an object thereof is to allow character display attributes for an application to be shared among multiple applications and/or multiple information processing apparatuses.

In addition to the aforementioned object, obtaining advantageous effects, which are achieved by configurations described in the best mode for the practicing the embodiments described later and are not obtained from conventional techniques are also considered as objects of the present embodiments.

### SUMMARY

In order to achieve the above-described object, provided herein is a display controller including: a processor, the processor being adapted to: generate character attribute information based on a display condition for a first application; record the generated character attribute information in a storage device; and in response to a second application being launched, obtain the character attribute information from the storage device, and change a display condition for the second application, based on the obtained character attribute information.

Additionally, provided herein is an information processing apparatus including: a display unit; and a processor, the processor being adapted to: generate character attribute information based on a display condition for a first application in the display unit; record the generated character attribute information in a storage device; and in response to a second application being launched, obtain the character attribute information from the storage device, and change a display condition for the second application, based on the obtained character attribute information.

Further, provided herein is a display control method including: generating character attribute information based on a display condition for a first application; recording the generated character attribute information in a storage device; in response to a second application being launched, obtaining the character attribute information from the storage device; and changing a display condition for the second application, based on the obtained character attribute information.

Additionally, provided herein is a non-transitory computer-readable storage medium having a display control program stored therein, the program, when being executed by a computer, causing the computer to: generate character attribute information based on a display condition for a first application; record the generated character attribute information in a storage device; in response to a second application being launched, obtain the character attribute information from the storage device; and change a display condition for the second application, based on the obtained character attribute information.

Further, provided herein is an information processing system including: a higher-level apparatus; and an information processing apparatus connected to the higher-level apparatus via a network, wherein the information processing apparatus includes: a display unit; and a processor, the processor being adapted to: generate character attribute information based on a display condition for a first application; send the generated character attribute information to the higher-level apparatus; in response to a second application being launched, obtain the character attribute information from the higher-level apparatus, and change a display condition for the second application, based on the obtained character attribute information, and the higher-level apparatus includes: a second processor; and a storage device that stores the character attribute information sent from the information processing apparatus, the second processor being adapted to: send the character attribute information stored in the storage device, to the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating the entire configuration of an information processing system as one example of an embodiment;

FIG. 2 is a schematic diagram illustrating the system configuration of a mobile device as one example of an embodiment;

FIG. 3 is a schematic diagram illustrating a configuration of a server as one example of an embodiment;

FIG. 4 is a diagram illustrating an example of display modes of an information processing system as one example of an embodiment, wherein (a) illustrates a screen prior to a mode change, (b) illustrates the character arrangement change mode, and (c) illustrates the layout change mode;

FIG. 5 is a flowchart illustrating display control processing in the mobile device as one example of an embodiment;

FIG. 6 is a diagram illustrating processing for obtaining a character attribute by the mobile device as one example of an embodiment;

FIG. 7 is a diagram illustrating processing for obtaining a character attribute by the mobile device as one example of an embodiment;

FIG. 8 is a diagram illustrating an example of a character attribute file in the mobile device;

FIG. 9 is a diagram illustrating processing for obtaining a character attribute by in the mobile device as one example of an embodiment;

FIG. 10 is a diagram illustrating an example of a screen display in the mobile device as one example of an embodiment;

FIG. 11 is a diagram illustrating an example of processing for reflecting a character attribute by the mobile device as one example of an embodiment;

FIG. 12 is a diagram illustrating an example of processing for reflecting a character attribute by the mobile device as one example of an embodiment;

FIG. 13 is a flowchart illustrating processing for obtaining a character attribute in the PC as one example of an embodiment;

FIG. 14 is a flowchart illustrating reflecting a character attribute setting from the PC to the mobile device as one example of an embodiment;

FIG. 15 is a flowchart illustrating processing for calculating character arrangements in a server as a modification to an embodiment;

FIG. 16 is a flowchart illustrating processing for obtaining a character attribute in an information processing system as one example of an embodiment; and

FIG. 17 is a diagram illustrating an example of a screen capture in an information processing system as one example of an embodiment.

### DESCRIPTION OF EMBODIMENTS

Hereinafter, an embodiment will be described with reference to the drawings. Note that embodiments descried below are merely exemplary, and it is not intended that various modifications and variations that are not explicitly described, are not excluded. In other words, the present embodiments may be practiced by modifying in a various manner (such as combining any of embodiments and modifications thereto), without departing from the spirit thereof.

(A) Configuration

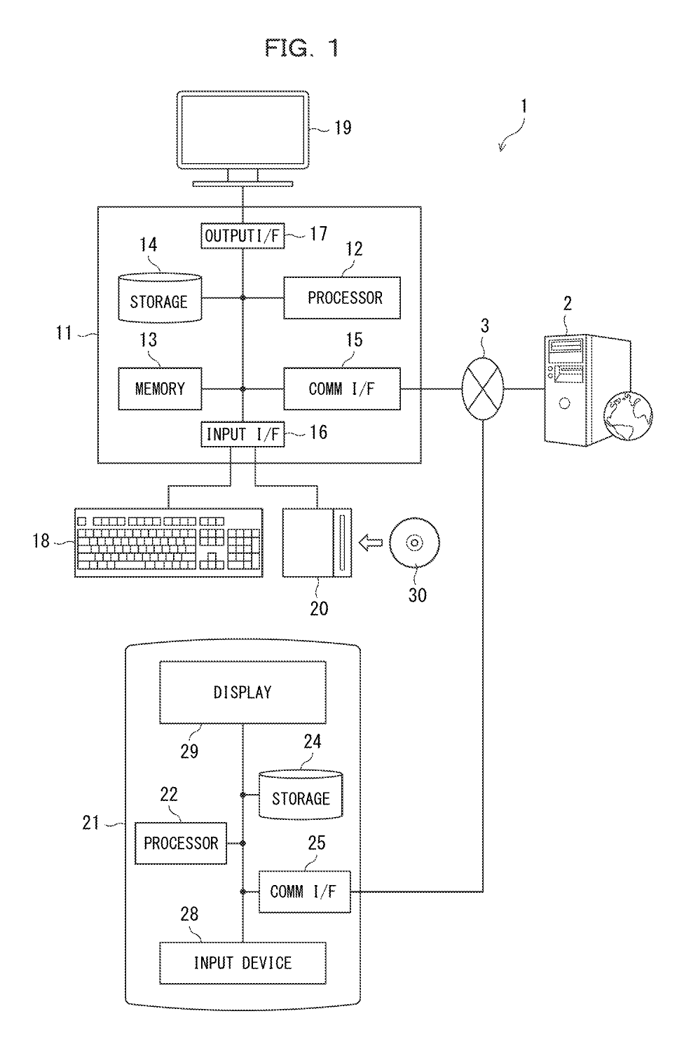

A configuration of an information processing system 1 as one example of an embodiment will be described with reference to FIGS. 1 to 4.

FIG. 1 is a schematic diagram illustrating the entire configuration of the information processing system 1 as one example of an embodiment.

A server (storage device, higher-level apparatus) 2 is provided in the information processing system 1, and a PC (information processing apparatus, first information processing apparatus) 11 and a mobile device (information processing apparatus, second information processing apparatus) 21 are connected to the server 2 via a network 3, e.g., the Internet. In this example, the PC 11 and the mobile device 21 are used by one user. Hereinafter, the PC 11 and the mobile device 21 may be collectively referred to as “devices 11 and 21”.

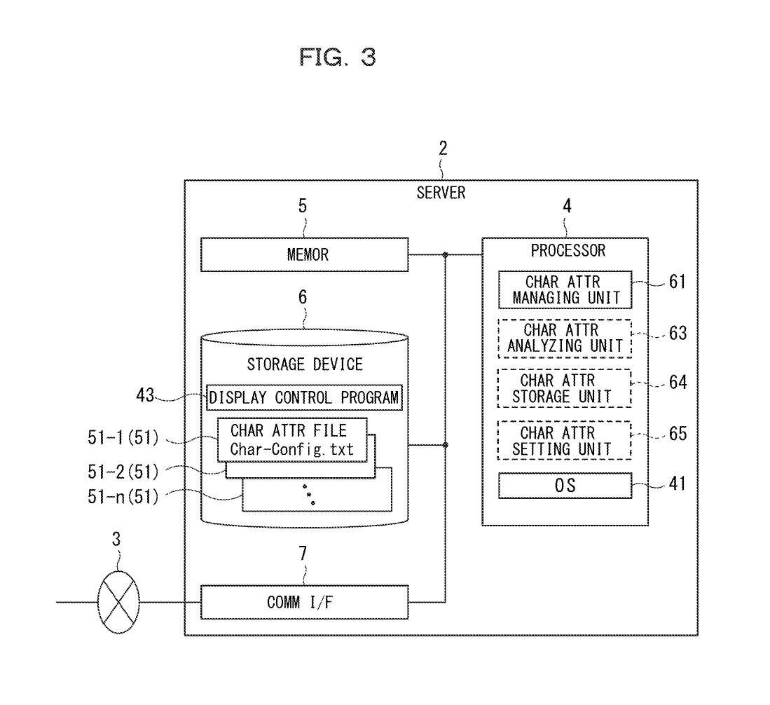

The server 2 is an information processing apparatus having a server function, and receives character attribute data from the PC 11 and/or the mobile device 21 and saves it as character attribute files 51-1 through 51-n (n is an integer of one or more) depicted in FIG. 3, as will be described later. The detailed configuration of the server 2 will be described later with reference to FIG. 3.

The PC 11 is a computer, such as a notebook computer or a desktop computer, for example.

The PC 11 includes a processor 12, a memory 13, a storage device 14, communication interface (I/F) 15, an input interface 16, and an output interface 17.

The processor 12 performs various types of computation processing by executing programs stored in the memory 13 and/or the storage device 14, and executes various controls in the PC 11.

The processor 12 executes an operating system (OS, not illustrated) that is system software implementing basic functions for the PC 11. The processor 12 also performs various types of processing by executing programs stored in the memory 13 (described later) and the like.

The memory 13 stores programs executed by the processor 12, various types of data, and data obtained through operations of the processor 12. The memory 13 may be any of various types of well-known memory, e.g., a random access memory (RAM) and a read only memory (ROM), for example. Alternatively, multiple types of memory may also be used.

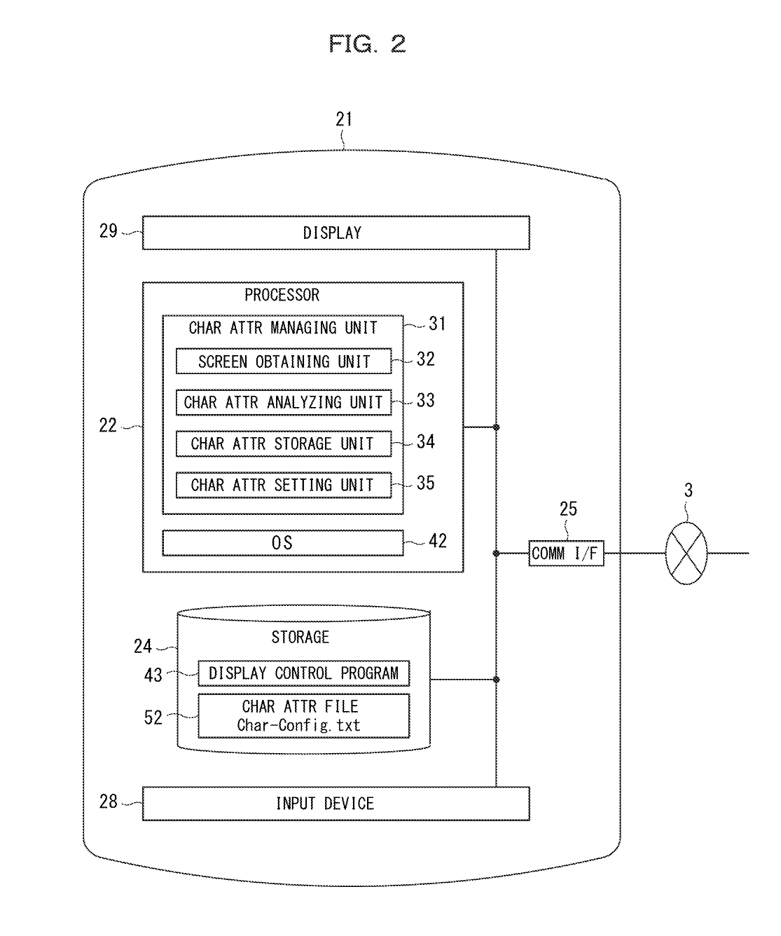

The storage device 14 provides the PC 11 of storage areas for storing the OS and various types of programs (not illustrated) that are executed on the PC 11, for example. The storage device 14 also stores character attribute files 51 (refer to FIG. 2; described later). The storage device 14 is a hard disk drive (HDD) or a solid state drive (SSD), for example, and is provided internally or externally.

The communication interface 15 is an interface that connects the PC 11 via a wire or wirelessly to the network 3, e.g., the Internet. The communication interface 15 is a wired or wireless local area network (LAN) card, or a wired or wireless wide area network (WAN) card, for example.

The input interface 16 is an interface for receiving data from a peripheral device external to the PC 11, and is a Universal Serial Bus (USB) interface, or a radio or infrared interface, for example.

The output interface 17 is an interface for transferring data to a peripheral device external to the PC 11, and is a display interface, a USB interface, a radio or infrared interface, for example.

The PC 11 is connected to an input device 18 and a medium reader 20 via the input interface 16, and to a display 19 via the output interface 17.

The input device 18 is an input device used by the user of the PC 11 for providing various inputs and selection operations, and is a keyboard, a mouse, a touch panel, or a microphone, for example. While the input device 18 is depicted as an external keyboard of the PC 11 in FIG. 1, the input device 18 may be provided inside the PC 11. If the input device 18 is a touch panel, the input device 18 may also function as the display 19 (described later).

The display 19 is a display device which is capable of displaying various types of information, and is a liquid crystal display or a cathode ray tube (CRT), for example. While the display 19 is depicted as an external display of the PC 11 in FIG. 1, the display 19 may be provided inside the PC 11. If the input device 18 is a touch panel, the input device 18 may also function as the display 19.

The medium reader 20 is a drive that reads from or writes to a storage medium 30, such as a CD (e.g., a CD-ROM, a CD-R, or a CD-RW), a DVD (e.g., a DVD-ROM, a DVD-RAM, a DVD-R, a DVD+R, a DVD-RW, or a DVD+RW), or a Blu Ray disk. While the medium reader 20 is depicted as an external drive of the PC 11 in FIG. 1, the medium reader 20 may be provided inside the PC 11.

The mobile device 21 is a mobile device, e.g., a mobile phone or a smart phone, for example.

The mobile device 21 includes a processor 22, a storage device 24, a communication interface 25, an input device 28, and a display 29.

The processor 22 performs various types of computation processing by executing programs stored in the storage device 24, and executes various controls in the mobile device 21.

The processor 22 executes the OS (refer to FIG. 2) that is system software implementing basic functions for the mobile device 21. The processor 22 also performs various types of processing by executing programs stored in the storage device 24 (described later) and the like.

The storage device 24 stores programs executed by the processor 22, various types of data, and data obtained through operations of the processor 22. The storage device 24 may be any of well-known memory devices in various types, e.g., a RAM and a ROM, for example. Alternatively, the storage device 24 may be any other storage device, such as a HDD or an SSD. The storage device 24 stores a character attribute file 52 (refer to FIG. 2; described later).

The communication interface 25 is an interface that connects the mobile device 21 to the network 3, e.g., the Internet, via a third-generation mobile communication (3G) network. The communication interface 25 is an interface for a 3G, Long Term Evolution (LTE), or Wi-Fi (Wireless Fidelity) network, for example.

The input device 28 is an input device used by the user of the mobile device 21 for entering various inputs and selection operations, and is a numeric keypad, a touch panel, or a microphone, for example.

The display 29 is a display device which is capable of displaying various types of information, and is a liquid crystal display or a touch panel, for example. If the input device 28 is a touch panel, the input device 28 may also function as the display 29.

FIG. 2 is a schematic diagram illustrating a system configuration of the mobile device 21 as one example of an embodiment.

The processor 22 in the mobile device 21 functions as a character attribute managing unit (display controller) 31, by executing a display control program 43 stored in the storage device 24.

The character attribute managing unit 31 includes a screen obtaining unit 32, a character attribute analyzing unit 33, a character attribute storage unit 34, and a character attribute setting unit 35.

The screen obtaining unit 32 obtains (screen-captures) an image of an application that is currently being executed on the mobile device 21 and is being displayed on the display 29, in a form of a bitmap file, for example. The screen obtaining unit 32 obtains screen-captured images of an application, when the application is launched for the first time, or when the character attribute is changed in that application. As used herein, the term “character attribute” refers to attribute information for displaying characters (characters) are to be displayed in an application, and are the sizes of characters, the font types (character typefaces), the color of the characters (foreground color), the background color, and the like, for example.

The character attribute analyzing unit 33 analyzes characters in an image screen-captured by the screen obtaining unit 32, to recognize a character attribute (obtain character attribute information) of characters being displayed in an application that is being executed. The character attribute analyzing unit 33 uses any of optical character recognition (OCR) techniques for recognizing the character attribute. Since the OCR techniques are widely used in the art, detailed descriptions thereof will be omitted.

If there are different font types and/or colors of characters in a screen-captured image, the character attribute analyzing unit 33 selects the character attribute of characters that appear the most frequently (most prevalent) in a screen-captured image.

For analyzing characters in a screen-captured image, the character attribute analyzing unit 33 recognizes non-text characters in images or flush movies, in addition to information on characters in the text format.

Here, the character attribute analyzing unit 33 calculates a character size, as a value in a unit of millimeter (mm) representing the size of characters actually displayed on the screen, for example. For instance, the character attribute analyzing unit 33 calculates the size of characters displayed on the screen (on-screen character display size), from the dot count of a displayed character, for example, using the following Formula:

On-screen character display size (mm)=dot count of character/resolution (dpi) (1)

where the dot count represents the dot count of a single character in the image screen-captured by the screen obtaining unit 32 (refer to FIG. 17).

The character attribute storage unit 34 saves the character attribute information obtained by the character attribute analyzing unit 33 in the storage device 24, as a character attribute file 52, and sends the character attribute file 52 to the server 2. While the file name of the character attribute file 52 is Char_Config.txt in FIG. 2, any suitable file name may be given.

The character attribute setting unit 35 receives, when an application is launched, a character attribute file 51 from the server 2 (described later), and stores the character attribute file 51 into the storage device 24, as a character attribute file 52. The character attribute setting unit 35 also displays characters in the application, based on the character attribute information in the character attribute file 51 received from the server 2.

More specifically, the character attribute setting unit 35 calculates the arrangement of characters in the application. The character attribute setting unit 35 may change the screen layout of the application automatically in accordance with the change in the character size, for improving visibility. Alternatively, the character attribute setting unit 35 may switch between the mode wherein the arrangement of characters are changed while the layout of images and the like are maintained (character arrangement change mode); and the mode wherein the layout of images and the like are changed while the arrangement of characters are maintained (layout change mode). In the character arrangement change mode, the character attribute setting unit 35 calculates arrangement positions of characters and the like in an application using an algorithm, such as the Seamless Document Handling® technique developed by Fuji Xerox Co., Ltd. For information on the Seamless Document Handling technique, refer to http://www.fujixerox.co.jp/company/technical/main_technology/delivering/seamless.html on the Internet (last searched on Apr. 17, 2013).

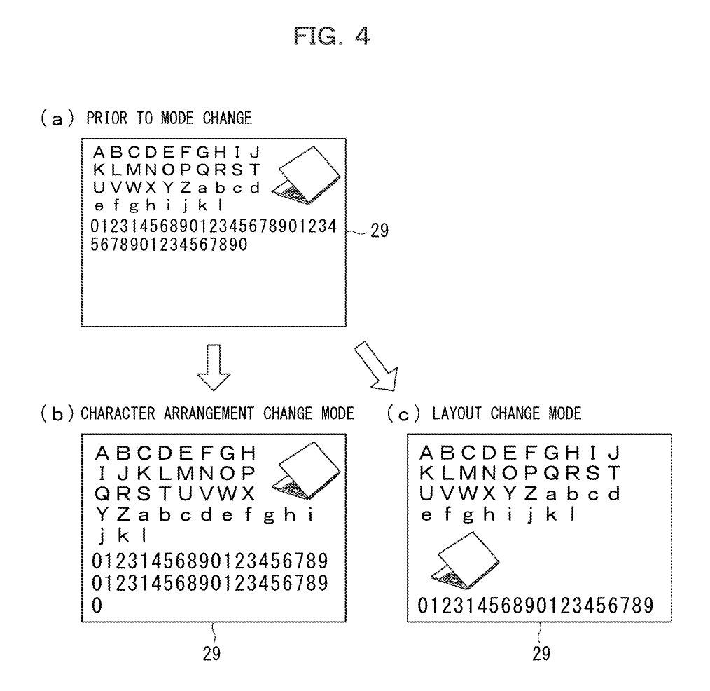

FIG. 4 is a diagram illustrating an example of display modes in the information processing system 11 as one example of an embodiment, wherein (a) illustrates a screen prior to a mode change, (b) illustrates the character arrangement change mode, and (c) illustrates the layout change mode.

Note that the above-described operations by the screen obtaining unit 32, the character attribute analyzing unit 33, the character attribute storage unit 34, and the character attribute setting unit 35 are executed at the time when an application is launched for the first time, and every time when a character attribute is changed in this application.

While the configuration of the mobile device 21 is illustrated in FIG. 2, also in the PC 11, the processor 12 functions as a character attribute managing unit 31 by executing a display control program 43 stored in the storage device 14, in the similar manner.

The character attribute managing unit 31 in the PC 11 similarly includes a screen obtaining unit 32, a character attribute analyzing unit 33, a character attribute storage unit 34, and a character attribute setting unit 35. Since the configurations and functions thereof are similar to those of the mobile device 21 described above with reference to FIG. 2, descriptions and illustrations therefor are omitted.

FIG. 3 is a schematic diagram illustrating a configuration of the server 2 as one example of an embodiment.

The server 2 includes a processor 4, a memory 5, a storage device 6, and a communication interface 7.

The processor 4 performs various types of computation processing by executing programs stored in the memory 5 and/or the storage device 6, and executes various controls in the server 2.

The processor 4 executes an OS 41 that is system software implementing basic functions for the server 2. The processor 4 also performs various types of processing by executing programs stored in the memory 5 (described later) or the like.

The memory 5 stores programs executed by the processor 4, various types of data, and data obtained through operations of the processor 4. The memory 5 may be any of various types of well-known memory, e.g., a RAM and a ROM, for example. Alternatively, multiple types of memory may also be used.

The storage device 6 provides the server 2 of storage areas, and stores the OS 41 and various programs being executed on the server 2, for example. The storage device 6 may also function as a storage device that stores character attribute files 51-1, 51-2, . . . , 51-n corresponding to each user, for a PC 11 and/or a mobile device 21 owned by that user. The storage device 6 is a HDD or SSD, for example, and is provided internally or externally.

Note that, hereinafter, the reference symbols 51-1 through 51-n are used when a reference to a specific one of the plurality of character attribute files is to be made while reference symbol 51 is used when reference is made to anyone of the character attribute files.

Here, n is an integer of one or more and is the total number of users in the information processing system.

The communication interface 7 is an interface that connects the server 2 to the network 3, e.g., the Internet, via a wire or wirelessly. The communication interface 7 is a wired or wireless LAN card, or a wired or wireless WAN card, for example.

The processor 4 in the server 2 functions as a character attribute managing unit 61, by executing the display control program 43 stored in the storage device 6.

In response to the character attribute for the application being changed on the device 11 or 21 owned by a user, the character attribute managing unit 61 receives the character attribute file 52 from the PC 11 or the mobile device 21, and stores it as a character attribute file 51 related to that user, in the storage device 6. In response to an application being launched on the PC 11 or the mobile device 21, the character attribute managing unit 61 receives a request for the character attribute file 51 from the PC 11 or the mobile device 21, and sends the file to the device 11 or 21.

Here, the character attribute managing unit 61 may relate users to their corresponding character attribute files 51, using identifiers (user IDs) of the users. As an example, when a user with a user ID “Azby000001” has a PC 11 (Device a) and a mobile device 21 (Device b), the character attribute managing unit 61 saves information on display of each of the Devices a and b, for example, as a character attribute file 51 of that user, as follows:

### User ID: Azby000001

Display size of Device a: 17 inches
Horizontal size of display size of device a: 1280 pixels
Vertical size of display size of device a: 1024 pixels
Display size of Device b: 7 inches
Horizontal size of display size of device b: 1280 pixels
Vertical size of display size of device b: 800 pixels

Note that registration of devices 11 and 21 for each user may be made from a user registration site provided by the manufacturer of the device, for example. For making registration, the user may be prompted to supply information on the device 11 and/or 21, such as the display size, the vertical size, and the horizontal size. Alternatively, the user may be prompted to select the model name of the device 11 and/or 21, and display information of the selected model may be obtained from the product database from the manufacturer.

It has been described, with reference to FIG. 2, that the screen obtaining unit 32 in the PC 11 or the mobile device 21 obtains a screen-captured image of an application, and the character attribute analyzing unit 33 analyzes the image to recognize the character attribute.

In a modification to the present embodiment, in contrast, the server 2 may recognize a character attribute. In this modification, the processor 4 in the server 2 includes functions as a character attribute analyzing unit 63, a character attribute storage unit 64, and a character attribute setting unit 65.

Specifically, the character attribute managing unit 61 in the server 2 receives, from the PC 11 or the mobile device 21, a screen-captured image of an application.

The character attribute analyzing unit 63 then recognizes a character attribute of the characters in the screen-captured image received from the PC 11 or the mobile device 21, using an OCR technique.

The character attribute storage unit 64 saves the character attribute information obtained by the character attribute analyzing unit 63, in the storage device 6 as a character attribute file 51.

The character attribute setting unit 65 determines the screen arrangement for the application on the PC 11 or the mobile device 21 and sends the determined results to the PC 11 or to the mobile device 21. For example, the character attribute setting unit 65 may change the screen layout of the application automatically in accordance with the change in the character size, for improving visibility. In this case, the character attribute setting unit 65, for example, as depicted in FIG. 4 (a) to (c), may calculate the screen arrangement in the mode wherein the arrangement of characters are changed while the layout of images and the like is maintained (character arrangement change mode); or the screen arrangement in the mode wherein the layout of images and the like is changed while the arrangement of characters are maintained (layout change mode). In the character arrangement change mode, the character attribute setting unit 65 calculates arrangement positions of characters and the like in an application on the PC 11 or the mobile device 21, using an algorithm, such as the Seamless Document Handling technique described above.

Note that, in the above-described embodiment, the processors 12 and 22 in the devices 11 and 21 are adapted to function as the character attribute managing unit 31, the screen obtaining unit 32, the character attribute analyzing unit 33, the character attribute storage unit 34, and the character attribute setting unit 35 by executing the display control program 43.

Furthermore, the processor 4 in the server 2 is adapted to function as the character attribute managing unit 61, the character attribute analyzing unit 63, the character attribute storage unit 64, and the character attribute setting unit 65, by executing the display control program 43.

Note that the program (display control program 43) for embodying the functions as the character attribute managing unit 31, the screen obtaining unit 32, the character attribute analyzing unit 33, the character attribute storage unit 34, and the character attribute setting unit 35 is provided while being stored in a computer-readable storage medium 30, such as a flexible disk, a CD (e.g., a CD-ROM, CD-R, CD-RW), a DVD (e.g., DVD-ROM, DVD-RAM, DVD-R, DVD+R, DVD-RW, DVD+RW), a magnetic disk, an optical disk, a magneto-optical disk, and the like, for example. A computer reads the program from the storage medium 30 and transfers it into an internal storage device, before using it. The program may be stored on a storage device (storage medium 30), such as a magnetic disk, an optical disk, a magneto-optical disk, for example, and may be provided to the computer from that storage device through a communication path.

When embodying the functions as the character attribute managing unit 31, the screen obtaining unit 32, the character attribute analyzing unit 33, the character attribute storage unit 34, and the character attribute setting unit 35, a program stored in an internal storage device (the memory 13 and/or the storage devices 14 and 24 in the devices 11 and 21, in the present embodiment) is executed by a microprocessor in a computer (the processors 12 and 22 in the devices 11 and 21, in the present embodiment). The computer may read the program stored in the storage medium 30 and execute the program.

Furthermore, when embodying the functions as the character attribute managing unit 61, the character attribute analyzing unit 63, the character attribute storage unit 64, and the character attribute setting unit 65, a program stored in an internal storage device (the memory 5 and/or the storage device 6 in the server 2, in the present embodiment) is executed by a microprocessor in a computer (the processor 4 in the server 2, in the present embodiment). The computer may read the program stored in a storage medium and execute the program.

Note that, in the present embodiment, the term “computer” may be a concept including hardware and an operating system, and may refer to hardware that operates under the control of the operating system. Alternatively, when an application program alone can make the hardware to be operated without requiring an operating system, the hardware itself may represent a computer. The hardware includes at least a microprocessor, e.g., CPU, and a means for reading a computer program recorded on a storage medium and, in the present embodiment, the devices 11 and 21 and the server 2 include a function as a computer.

(B) Operations

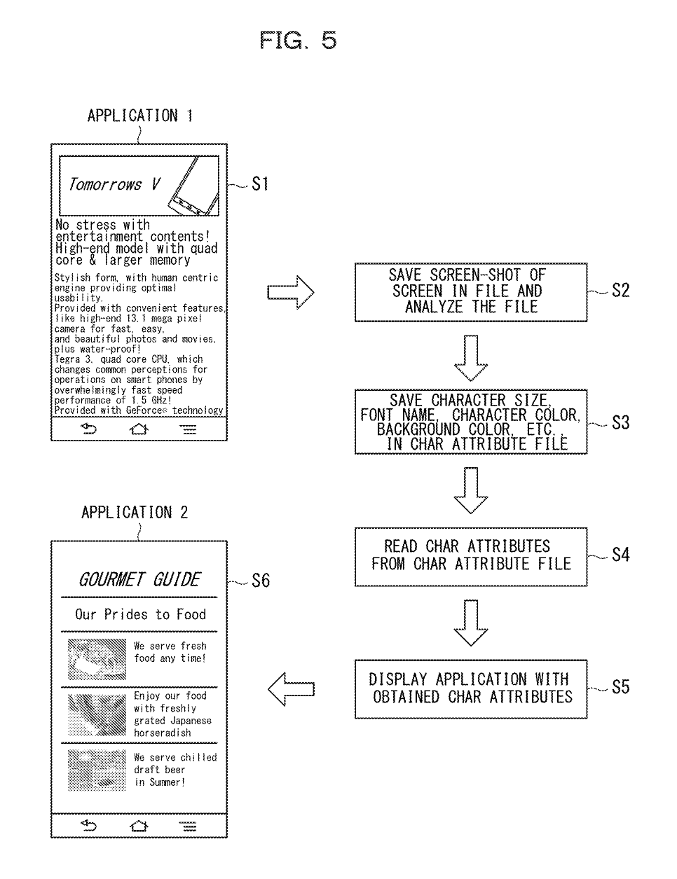

Next, display control processing in the information processing system 1 as one example of an embodiment will be described with reference to FIGS. 5 to 17.

Initially, display control processing in the PC 11 and the mobile device 21 will be described with reference to FIGS. 5 to 12.

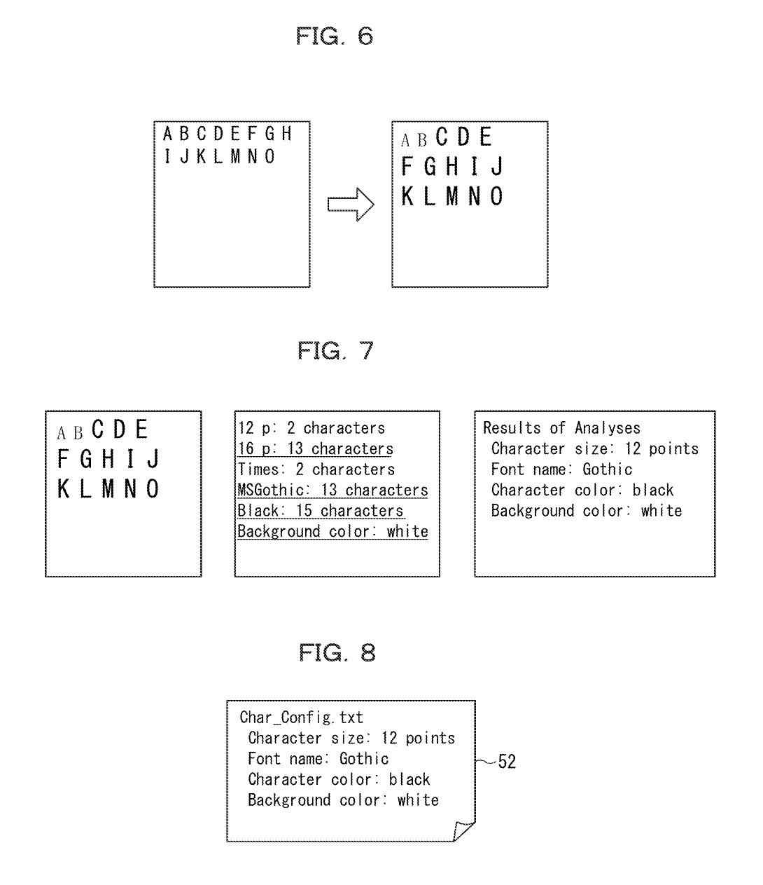

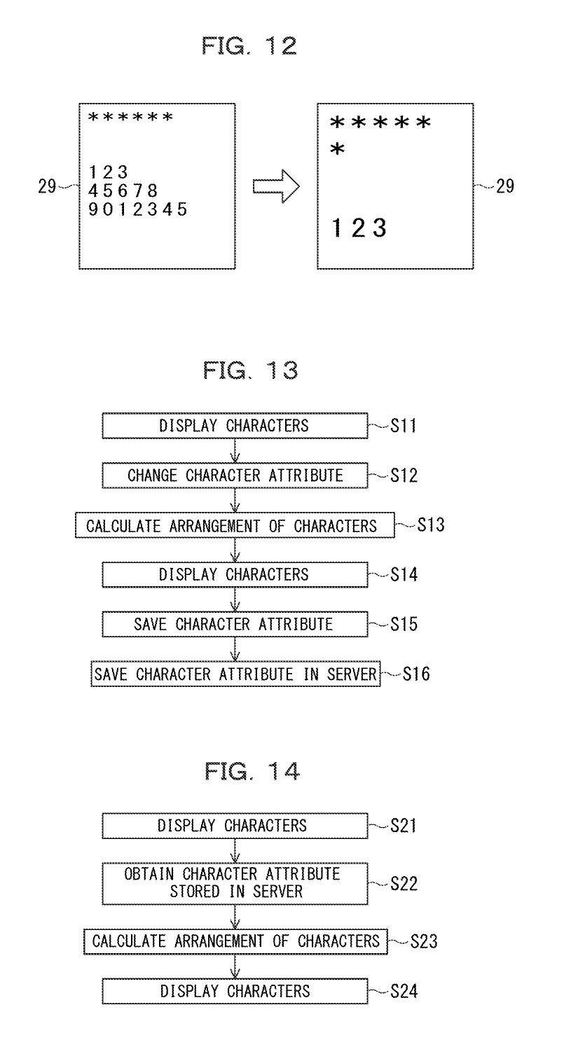

FIG. 5 is a flowchart (Steps S1 to S6) illustrating display control processing in the mobile device 21 as one example of an embodiment. FIGS. 6-7 and 9 are diagrams illustrating an example of processing for obtaining a character attribute by the mobile device 21, while FIG. 8 is a diagram illustrating an example of a character attribute file 52 in the mobile device 21. FIG. 10 is a diagram illustrating an example of a screen display in the mobile device, and FIGS. 11 and 12 are diagrams illustrating an example of processing for reflecting a character attribute by the mobile device 21.

In this example, in response to a character attribute being changed in an application, the character attribute analyzing unit 33 in the mobile device 21 recognizes the character attribute. While display control processing in the terminal device 21 is described here, the similar processing is also executed on the PC 11.

In the present example, a user of the mobile device 21 executes an application 1 (first application).

In Step S1 in FIG. 5, the user of the mobile device 21 changes the character size and the font for the application 1. For example, the user changes the display of characters in the application 1 as depicted in FIG. 6. In the example depicted in FIG. 6, the user changes the font for “AB” to “Times”, and enlarges the character “CDEFGHIJKLMNO”.

Next, in Step S2, the screen obtaining unit 32 saves a screen-captured image of the application 1 on the mobile device 21 in a bitmap file format, for example, and the character attribute analyzing unit 33 analyzes the bitmap file to recognize the character attribute. Specifically, as depicted in FIG. 7, the character attribute analyzing unit 33 recognizes that there are two characters with 12-point Times font and 16 characters with 16-point Gothic font in the bitmap file, and that the character color is black and the background color is white.

In this example, the character attribute analyzing unit 33 selects the character size of 12 points, the font name of “Gothic”, the character color of Black, and the background color of White, from the character attribute of the most prevalent characters.

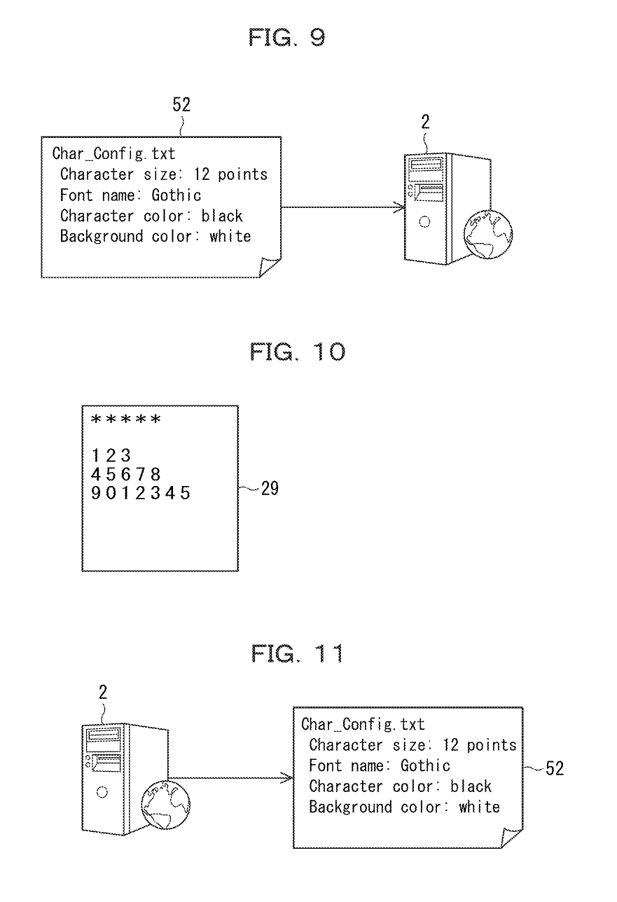

In Step S3 in FIG. 5, the character attribute storage unit 34 saves (stores, records) the character attributes (e.g., character size, font name, character color, and background color) recognized by the character attribute analyzing unit 33 in Step S2, as a character attribute file 52 (Char_Config.txt), as depicted in FIG. 8. Then, as depicted in FIG. 9, the character attribute storage unit 34 sends the character attribute file 52 to the server 2.

Next, in Step S4 in FIG. 5, the user of the mobile device 21 launches another application 2 (second application). In response, as depicted in FIG. 10, the application 2 is displayed on the display 29 using the default character size for the application 2.

Next, as depicted in FIG. 11, the character attribute setting unit 35 obtains a corresponding character attribute file 51 from the server 2, saves the obtained character attribute file 51 as a character attribute file 52, and reads character attribute information from the character attribute file 52.

In Step S5, the character attribute setting unit 35 changes the display of characters in the application 2, based on the character attribute read in Step S4.

In Step S6, as depicted in FIG. 12, the character size for the application 2 is changed to the character size for the application 1 and characters are displayed in the display 29.

In this example, in response to a character attribute being changed in an application, the character attribute analyzing unit 33 in the mobile device 21 recognizes the character attribute. While display control processing in the terminal device 21 is described hereinafter, the similar processing is also executed in the PC 11.

Next, with reference to FIGS. 13 to 14, how the character attribute is changed in an application on the PC 11 and how that change is reflected to the mobile device 21 will be described.

FIG. 13 is a flowchart (Steps S11 to S16) illustrating processing for obtaining a character attribute in the PC 11 as one example of an embodiment.

In Step S11, when a user launches an application on the PC 11, characters are displayed in the application, based on a default character attribute for the application that has been set in the PC 11, for example.

Next, in Step S12, the user of the PC 11 changes the character attribute of characters being displayed on the application launched in Step S11.

In Step S13, the character attribute setting unit 35 in the PC 11 calculates the arrangement positions of characters in the application.

In Step S14, characters are displayed in the application in accordance with the calculated character arrangement. The screen obtaining unit 32 in the PC 11 saves a screen-captured image of the application on the PC 11 in a form of a bitmap file, for example. The character attribute analyzing unit 33 in the PC 11 then analyzes the bitmap file to recognize the character attribute.

In Step S15, the character attribute storage unit 34 in the PC 11 saves information of the character attribute recognized by the character attribute analyzing unit 33 in Step S14, in a character attribute file 52.

In Step S16, the character attribute storage unit 34 in the PC 11 sends the character attribute file 52 saved in Step S15, to the server 2.

FIG. 14 is a flowchart (Step S21 to S24) illustrating reflecting a character attribute setting from the PC 11 to the mobile device 21 as one example of an embodiment.

After Step S16 in FIG. 13, in Step S21 in FIG. 14, the user launches an application on the mobile device 21. In this example, characters are displayed in the application based on a default character attribute for the application, for example.

Next, in Step S22, the character attribute setting unit 35 in the terminal device 21 obtains a corresponding character attribute file 51 from the server 2.

In Step S23, the character attribute setting unit 35 in the terminal device 21 calculates the arrangement positions of characters in the application.

In Step S24, the application is displayed on the mobile device 21 in the calculated character arrangement.

While the change in the character attribute in the application on the PC 11 is reflected to the application on the mobile device 21 in this example, the processing in FIGS. 13 and 14 is also executed for reflecting a change in a character attribute in an application on the mobile device 21 to the PC 11.

As a modification to an embodiment, the arrangement of characters in Step S23 described above may be calculated on the server 2.

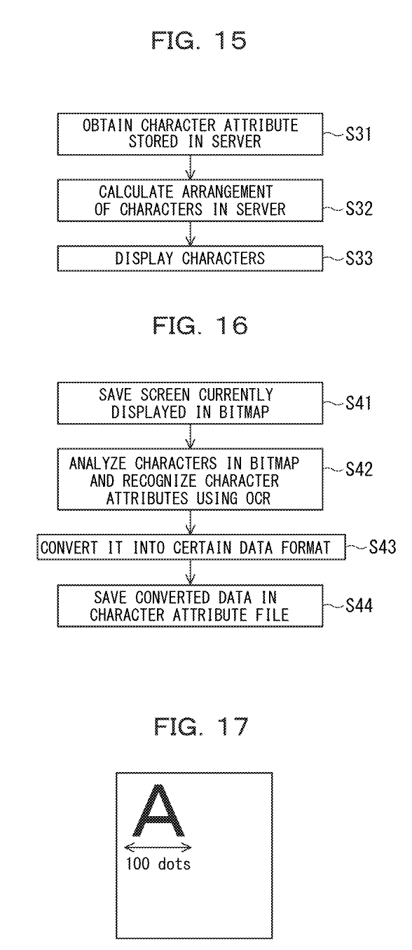

FIG. 15 is a flowchart (Steps S31 to S33) illustrating processing for calculating character arrangements in the server 2 as a modification to an embodiment.

In response to an application being launched by a user on the mobile device 21, in Step S31 in FIG. 15, the character attribute setting unit 35 in the mobile device 21 obtains a corresponding character attribute file 51 from the server 2.

Next, in Step S32, the character attribute setting unit 65 in the server 2 calculates the arrangement positions of characters and the like in the application, and sends the results to the mobile device 21.

In Step S33, the application is displayed on the mobile device 21 by the character attribute setting unit 65 in accordance with the character arrangement received from the server 2.

FIG. 16 is a flowchart (Steps S41 to S44) illustrating processing for obtaining a character attribute in the information processing system 1 as one example of an embodiment, while FIG. 17 is a diagram illustrating an example of a screen capture in the information processing system 1.

In Step S41 in FIG. 16, when a user of the PC 11 (or the mobile device 21) changes a character attribute in an application, the screen obtaining unit 32 saves a screen-captured image of the application in a form of a bitmap file, for example.

Next, in Step S42, the character attribute analyzing unit 33 recognizes characters included in the bitmap file obtained in Step S41 using an OCR technique, and recognizes the character attribute of the recognized characters. As an example, as depicted in FIG. 17, the dot count of the most prevalent character size in the application is 100 dots, the size of the display 19 of the PC 11 is 17 inches, and the screen size is 1280 pixels×1024 pixels (horizontal×vertical) (with a resolution of 96 dpi).

In this exemplary display 19, the character display size is recognized as below using the above Formula (1):

Character size=100 dots/96 dpi=1.041 inches (2)

Here, 1.041 inches equal about 26.441 mm.

Next, in Step S43, the character attribute storage unit 34 converts the character attributes (e.g., character size, font name, character color, and background color) recognized by the character attribute analyzing unit 33 into a certain data format. Such data formats include the CSV format or other text formats, for example.

Finally, in Step S44, the character attribute storage unit 34 saves the data converted in Step S43 as a character attribute file 52 (Char_Config.txt). The character attribute storage unit 34 then sends the character attribute file 52 to the server 2.

Once the above-described processing is performed, the character size saved in the character attribute file 52 in Step S44 is used for applications that will be launched on the PC 11. Specifically, from the above Formula (1), the character size is recognized as:

1.041 inches×96 dpi=99.9 dots (3)

Thus, characters are displayed in a size of 99.9 dots in any applications that are subsequently launched.

(C) Advantageous Effects

As set forth above, in accordance with one example of the present embodiment, when the attributes for displaying characters (e.g., character size, font type, and character color) are changed for improving visibility of an application on the PC 11 or the mobile device 21, that change is reflected to character displays in other applications.

Further, since the changed character attributes are stored in a character attribute file 51 in the server 2, the user's preferred character attributes may also be reflected to another device 11 or 21 even after the user switched to that device 11 or 21.

As set forth above, in accordance with one example of the present embodiment, the usability of the devices 11 and 21 for users are improved.

Furthermore, one example of the present embodiment can also improve conveniences for users with visual problems, such as weakly-sighted or elderly people.

(D) Miscellaneous

The aforementioned techniques are not limited to the embodiments described above and various modifications can be made without departing from the spirit of the present embodiment.

For example, while character attributes of characters recognized are the size, font, color, character color, and background color in one example of the above-described embodiment, character attributes may also include other properties, such as bold or italic.

Furthermore, while the character display size is calculated from the dot count of the characters displayed on the screen in one example of the above-described embodiment, the character display size may be determined using any of other techniques.

As an example of such a technique for obtaining the character attributes, a markup language, e.g., the Hyper Text Markup Language (HTML); or a script language, e.g., the Cascading Style Sheet (CSS) or the JavaScript®, may be analyzed to determine the character attributes in an application being displayed, and the obtained character attributes may be stored.

In accordance with the disclosed technique, character display attributes for an application can be shared among multiple applications and/or multiple information processing apparatuses.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A display controller comprising:
a processor, the processor being adapted to:
generate character attribute information based on a display condition for a first application;
record the generated character attribute information in a storage device; and
in response to a second application being launched, obtain the character attribute information from the storage device, and change a display condition for the second application, based on the obtained character attribute information.

2. The display controller according to claim 1, wherein the character attribute information is at least one of a size of characters, a type of a character typeface, a character color, and a background color in the first application.

3. The display controller according to claim 1, wherein the processor is further adapted to:
obtain the display condition for the first application in a form of an image;
obtain the character attribute information of the first application by analyzing the obtained image.

4. An information processing apparatus comprising:
a display unit; and
a processor, the processor being adapted to:
generate character attribute information based on a display condition for a first application in the display unit;
record the generated character attribute information in a storage device; and
in response to a second application being launched, obtain the character attribute information from the storage device, and change a display condition for the second application, based on the obtained character attribute information.

5. The information processing apparatus according to claim 4, wherein the character attribute information is at least one of a size of characters, a type of a character typeface, a character color, and a background color in the first application.

6. The information processing apparatus according to claim 4, wherein the second application is executed on a second information processing apparatus that is different from the information processing apparatus.

7. The information processing apparatus according to claim 4, wherein the processor is further adapted to:
obtain the display condition for the first application in a form of an image;
obtain the character attribute information of the first application by analyzing the obtained image.

8. A display control method comprising:
generating character attribute information based on a display condition for a first application;
recording the generated character attribute information in a storage device;
in response to a second application being launched, obtaining the character attribute information from the storage device; and
changing a display condition for the second application, based on the obtained character attribute information.

9. The display control method according to claim 8, wherein the character attribute information is at least one of a size of characters, a type of a character typeface, a character color, and a background color in the first application.

10. The display control method according to claim 8, further comprising:
obtaining the display condition for the first application in a form of an image,
obtaining the character attribute information of the first application by analyzing the obtained image.

11. A non-transitory computer-readable storage medium having a display control program stored therein, the program, when being executed by a computer, causing the computer to:
generate character attribute information based on a display condition for a first application;
record the generated character attribute information in a storage device;
in response to a second application being launched, obtain the character attribute information from the storage device; and
change a display condition for the second application, based on the obtained character attribute information.

12. The non-transitory computer-readable storage medium according to claim 11, wherein the character attribute information is at least one of a size of characters, a type of a character typeface, a character color, and a background color in the first application.

13. The non-transitory computer-readable storage medium according to claim 11, wherein the program, when being executed by the computer, further causes the computer to:
obtain the display condition for the first application in a form of an image,
obtain the character attribute information of the first application by analyzing the obtained image.

14. An information processing system comprising:
a higher-level apparatus; and
an information processing apparatus connected to the higher-level apparatus via a network,
wherein the information processing apparatus comprises:
a display unit; and
a processor, the processor being adapted to:
generate character attribute information based on a display condition for a first application;
send the generated character attribute information to the higher-level apparatus;
in response to a second application being launched, obtain the character attribute information from the higher-level apparatus, and change a display condition for the second application, based on the obtained character attribute information, and
the higher-level apparatus comprises:
a second processor; and
a storage device that stores the character attribute information sent from the information processing apparatus, the second processor being adapted to:
send the character attribute information stored in the storage device, to the information processing apparatus.
